(19) United States
(12) Patent Application Publication
(10) Pub. No.: US 2010/0183769 A1
(43) Pub. Date: Jul. 22, 2010

(54) INFANT FORMULA COMPOSITIONS FOR NEONATES LACKING MOTHER'S OWN COLOSTRUM AND METHOD OF MAKING

(76) Inventor: Robert D. Christensen, Layton, UT (US)

Correspondence Address: SNELL & WILMER LLP (OC), 600 ANTON BOULEVARD, SUITE 1400, COSTA MESA, CA, 92626, US

(21) Appl. No.: 12/691,630

(22) Filed: Jan. 21, 2010

Related U.S. Application Data
(60) Provisional application No. 61/146,260, filed on Jan. 21, 2009.

(51) Int. Cl. A23L 1/305; A23L 1/302; A23L 1/304; A23C 9/152; A23C 9/158

(52) U.S. Cl. 426/72; 426/656; 426/580; 426/602; 426/74; 426/590; 426/311

(57) ABSTRACT

Colostrum solutions, their formulations and a method of making the solutions are presented. These solutions could be used in situations where the mother is not able to naturally provide colostrum to an infant.

### CROSS REFERENCE TO RELATED APPLICATIONS

This application claims the benefit of provisional application Ser. No. 61/146,260 filed Jan. 21, 2009 for Infant Formula Compositions for Neonates Lacking Mother's Own Colostrum and Method of Making, which is incorporated in this application as if fully set forth herein.

### BACKGROUND OF THE INVENTION

1. Field of the Invention

The present invention relates to synthetic infant formulas and specifically, to synthetic colostrum for initial feeding of neonates.

2. Description of the Related Art

Colostrum is nature's transition food between the non-caloric amniotic fluid swallowed by the fetus while in the womb and the mature human milk feedings which begin about one week after birth. Colostrum is a preparatory feeding substance. It has a composition that is considerably different from mature milk. Transition between colostrum and mature milk begins about three days after birth and is complete in about one week.

Table 1 below comparatively illustrates the constituent parts of mature milk as compared to natural colostrum.

TABLE 1

| Constituent per Liter | Mature Milk | | Colostrum (average) | |
|---|---|---|---|---|
| Protein | 10 | g | 23 | g |
| Fat | 40 | g | 10-30 | g |
| Carbohydrate | 72 | g | 53 | g |
| (lactose) | | | | |
| Calcium | 280 | mg | 230 | mg |
| Phosphorus | 140 | mg | 150 | mg |
| Sodium | 180 | mg | 480 | mg |
| Potassium | 530 | mg | 740 | mg |
| Chloride | 420 | mg | 750 | mg |
| Zinc | 1200 | ug | 5000 | ug |
| Vitamin E | 3150 | ug | 12800 | ug |
| Lactoferrin | 1700 | mg | 3300 | mg |
| Vitamin B12 | 260 | mg | 1000 | mg |

As can be seen from the chart, compared with natural mature milk, colostrum is much higher in concentrations of protein, sodium, potassium chloride and particularly minerals and vitamins. Yet, it is much lower in fat.

Commercially artificial formulas available for the mature milk feedings of neonates whose mothers do not provide human milk are based on bovine milk. There is no artificial formulation of colostrum available. Without artificial colostrum, many babies admitted to an NICU receive nothing by mouth for several days until either their mother produces colostrum or until an artificial formula or banked human milk feeding is begun. This period of receiving no nourishment by mouth is unnatural and may result in temporary disuse atrophy of small bowel mucosal villi, leading to feeding intolerance when feedings are begun.

In order to render mature milk or artificial formula more appropriate and better tolerated for ill or premature neonates, it has been proposed to dilute mature milk. However, from Table 1 above, it is clear that diluted milk does not approximate colostrum. Dilution reduces the fat content, but colostrum actually has more protein and certain minerals and vitamins than mature milk. Therefore, diluting mature milk or formula to make it better tolerated during the first days of life does not meet the unique physiologic needs of newborn infants in the first days.

It is, therefore imperative that a synthetic variety of colostrum be made available for use by neonates.

### SUMMARY OF THE INVENTION

The present invention contemplates synthetic colostrum solutions that could be used in situations for which the mother is not able to naturally provide colostrum to an infant Furthermore, more advanced colostrum formulations containing human milk and other relevant proteins, as well as human milk fat is contemplated.

### BRIEF DESCRIPTION OF THE DRAWINGS

FIG. 1 is a graph showing pre-feeding gastric residuals.

### DETAILED DESCRIPTION OF THE PREFERRED EMBODIMENTS

The artificial formulations of the present invention which are intended to simulate human colostrum are intended as a first food for neonates admitted to neonatal intensive care units. Feeding can begin in small quantities (10-30 mL/k/d) on the first day of life and be used in small volume feedings until the mother produces colostrum that can be used to feed the baby or until a mature milk substitute such as artificial formula or pasteurized banked human milk, begins. Further, in addition to neonatal intensive care units, it is proposed that these artificial colostrums can as well be used extensively in a baby nursery for well babies during the first and second day of life feeding when the mother chooses not to breastfeed or is unable to do so.

By utilizing these artificial formulations, the baby is being fed a substance that is well tolerated and physiological before artificial formulas based on cow's milk proteins are introduced into the infant's diet. This practice can be far better tolerated than the present practice of initiating feeding with mature milk formulas. The failure of human milk banks to produce colostrum as a product can be due to the fact that it is made in any given mother in very small quantities and for only a few days. Furthermore, it is felt that colostrum is so valuable to a mother's own baby that the ethics of harvesting colostrum are questionable.

In an embodiment, the present invention proposes a simple synthetic colostrum. An example of suitable constituents and amounts in the formulation of synthetic colostrum is shown below in Table 2. Further, a specific example of a formulation of synthetic colostrum is shown below in Table 3.

TABLE 2

| Sterile Water | Sufficient to make 1 | liter |
|---|---|---|
| CARBOHYDRATE | | |
| Lactose | 47.7-58.3 | grams |
| PROTEIN | | |
| Amino Acids | 20.7-25.3 | grams |
| FAT | | |
| Cholesterol | 270-330 | milligrams |
| Fatty Acids | 18-22 | grams |
| VITAMINS | | |
| MVI Ped | 27-33 | milliliter |
| Vitamin E | 11520-14080 | micrograms |
| Vitamin B12 | 1800-2200 | nanograms |
| B Carotene | 1008-1232 | micrograms |
| MINERALS | | |
| Sodium Acetate | 432-528 | milligrams Sodium |
| Potassium Chloride | 666-814 | milligrams Potassium |
| Calcium Gluconate | 207-253 | milligrams Calcium |
| Magnesium Sulfate | 31.5-38.5 | milligrams Magnesium |
| TRACE ELEMENTS | | |
| Zinc | 4500-5500 | micrograms |
| Copper | 1800-2200 | micrograms |
| Manganese | 450-550 | micrograms |
| Iodine | 450-550 | micrograms |
| Energy (kcal) | 453.6-554.4 | kcal |

TABLE 3

| Constituents | Source | Constituent/Liter | |
|---|---|---|---|
| Sterile Water | Sterile water USP | Q.S. | |
| CARBOHYDRATE | | | |
| Lactose | Lactose USP (solution) | 53 | g |
| PROTEIN | | | |
| Amino Acids | Trophamine | 23 | g |
| FAT | | | |
| Cholesterol | Cholesterol USP | 300 | mg |
| Fatty acids (linolenic, | Microlipid (50%) | 20 g (40 mL) | |
| oleic, palmitic, | | | |
| linolenic, stearic) | | | |
| VITAMINS | | | |
| Vitamins (MVI-PED) | MVI-PED | 30 | mL |
| Vitamin E | | 12800 | ug |
| Vitamin B12 | | 2000 | ng |
| β Carotene | | 1120 | ug |
| MINERALS | | | |
| Sodium acetate | | 480 | mg Na |
| Potassium chloride | | 740 | mg K |
| Calcium phosphate | | 230 | mg Ca |
| Magnesium sulfate | | 35 | mg Mg |
| TRACE ELEMENTS | Stock Solution | 5 | mL |
| Zinc | ″ | 5000 | ug |
| Copper | ″ | 2000 | ug |
| Manganese | ″ | 500 | ug |
| Iodine | ″ | 500 | ug |
| ENERGY (kcal) | | 504 | |

These Tables 2 and 3 illustrate sterile isotonic solutions that simulate human colostrum. The solutions are completely synthetic containing no intact proteins or peptides. Although they are an incomplete colostrum, these formulations are still tolerable by the neonate. Further, in an embodiment, natural human colostrum can be simulated by fewer constituents than presented in Tables 2 and 3. For example, a simpler solution can consist of only sterile water, carbohydrate, protein, and fat constituents without adding vitamins, minerals, and trace elements.

In an embodiment, the present invention also contemplates producing a colostrum formulation that can mix with human milk and/or relevant constituents including, but not limited to, lactoferrin, IgA, alpha lactalbumin and human milk fat. An example of suitable constituents and amounts in the formulation of a synthetic colostrum formulation to mix with human milk is shown below in Table 4. Further, an example of a specific formulation that can be mixed with a natural human milk solution is shown below in Table 5.

TABLE 4

| Sterile Water | Sufficient to make 1 | liter |
|---|---|---|
| CARBOHYDRATE | | |
| Lactose | 0-58.3 | grams |
| PROTEIN | | |
| Amino Acids | 20.7-25.3 | grams |
| FAT | | |
| No Added Fat | | |
| VITAMINS | | |
| MVI Ped | 27-33 | milliliter |
| Vitamin E | 11520-14080 | micrograms |
| Vitamin B12 | 1800-2200 | nanograms |
| MINERALS | | |
| Sodium Acetate | 432-528 | milligrams Sodium |
| Potassium Chloride | 666-814 | milligrams Potassium |
| Calcium Gluconate | 207-253 | milligrams Calcium |
| Magnesium Sulfate | 31.5-38.5 | milligrams Magnesium |
| TRACE ELEMENTS | | |
| Zinc | 4500-5500 | micrograms |
| Copper | 1800-2200 | micrograms |
| Manganese | 450-550 | micrograms |
| Iodine | 450-550 | micrograms |
| Energy (kcal) | 453.6-554.4 | kcal |

TABLE 5

| Constituents | Source | Constituent/Liter | |
|---|---|---|---|
| Sterile Water | Sterile water USP | Q.S. | |
| CARBOHYDRATE | | 53 | g |
| Lactose | Lactose USP (solution) | 27 | g |
| PROTEIN | | 23 | g |
| Amino Acids | Trophamine | 17 | g |
| FAT | | 2 | g |
| No added fat | No added fat | | |
| VITAMINS | | | |
| Vitamins (MVI-PED) | MVI-PED | 30 | mL |
| Vitamin E | | 12800 | ug |
| Vitamin B12 | | 2000 | ng |
| MINERALS | | | |
| Sodium acetate | | qs to total 480 | mg Na |
| Potassium chloride | | qs to total 740 | mg K |
| TRACE ELEMENTS | Stock Solution | 5 | mL |
| Zinc | ″ | 5000 | ug |
| Copper | ″ | 2000 | ug |
| Manganese | ″ | 500 | ug |
| Iodine | ″ | 500 | ug |
| ENERGY (kcal) | | 480 | |

Since a separate milk solution is also required in the solutions of Tables 4 and 5, these formulations can be more expensive to produce than the solutions of Table 2 and 3. However, they can also provide significant advantages. For example, the solution exemplified in Table 5 is produced by starting with 500 mL of human milk to which is added Lactose USP, Trophamine, MVI, sodium acetate, potassium chloride and a trace element stock solution containing zinc, cooper, manganese and iodine, for example, and sterile water USP to make up a one liter volume. With the more expensive milk constituent, the solution exemplified in Table 5 contains human milk proteins and human milk fat. It can also contain human lactoferrin, human alpha lactalbumin, human casein, and human IgA. As a result, this solution of Table 5 can be a more complete simulation of natural colostrum, and can also contain more immunological properties than the solution exemplified in Table 3. Further, fewer constituents can be formulated than presented in Tables 4 and 5. For example, a simpler solution can consist of only sterile water, carbohydrate, and protein without adding vitamins, minerals, and trace elements.

All solutions of the present invention can be made in the same manner that solutions are made using stock constituents. The solutions are not a biological product, i.e. they are not a product of human milk or animal milk. Rather, they are chemical compositions of basic nutritionals and USP constituents. An example of a formula and instructions for compounding an artificial colostrum formulation is below in Table 6.

TABLE 6

| | | |
|---|---|---|
| | Amount | |
| Ingredient | (mg/mcg/g/ml) | Amount (ml volume and concentration used) |

Items pumped in the clean room

| | | | |
|---|---|---|---|
| Trophamine 10% | 5 | gm | (50 ml * 10%) |
| Phytonadione | 0.6 | mg | (0.3 ml * 2 mg/ml) |
| (Vit K) | | | |
| Folic Acid | | | |
| Sodium Acetate | 166 | mg Na | (3.6 ml * Na Acetate 2 mEq/ml) |
| Sodium Phosphate | 74 | mg Na | (0.8 ml * Na Phos 4 mEq/ml) |
| Potassium | 370 | mg K | (4.75 ml * KCl 2 mEq/ml) |
| Chloride | | | |
| Calcium | 115 | mg Ca | (12.35 ml * Ca Gluc 10%) |
| Gluconate | | | |
| Magnesium | 17.5 | mg Mag | (0.355 ml * Mg Sulfate 50%) |
| Sulfate | | | |
| Zinc | 2.5 | mg | (2.5 ml * Zinc Sulfate (or Chloride) 1 mg/ml) |
| Copper | 1 | mg | (2.5 ml * Cupric chloride 0.4 mg/ml) |
| Manganese | 2.5 | mg | (2.5 ml * Manganese Chloride 0.1 mg/ml) |
| Chromium | | | |
| Selenium | | | |
| Iodine | 250 | mcg | (2.5 ml * Iodine 100 mcg/ml) |
| Sterile Water | 100 | ml | (100 ml) |

Items weighed/measured and added after items pumped in clean room

| | | | |
|---|---|---|---|
| Lactose | 26.5 | grams | (Stored with other compounding items) |
| Cholesterol NF | 150 | mg | (Stored in refrigerator by unit dose area) |
| Microlipids 50% | 5 | gm | 10 ml of Microlipids 50% |
| Poly-Vi-Sol | 1.5 | ml | |
| Sterile Water | qsad 500 | ml | |

Mixing directions:
1. Pump or add liquid ingredients in the IV room. (Note: DO NOT clamp the pump port of the IV bag.)
2. Weigh out all powder ingredients.
3. Open and drain the contents of a 500 ml bottle of sterile water for irrigation. (Save the water in a clean container for step #7.)
4. Add all of the liquid ingredients, except for the Microlipids and sterile water, to the empty container.
5. Add the powder ingredients to the same container.
6. Add the Microlipids.
7. Add sterile water to a total volume of 500 ml.
8. Add 0.5 ml of Sodium Hydroxide 50% to bring final pH to approximately 6.7 (use pH paper or Multistix).
9. Label container and give a 24 hour refrigerated expiration date.

The solutions of the present invention are feasible to feed to patients. When mother's own colostrum is not available for a neonatal intensive care unit (NICU) patient, the standard practice is to initiate feedings with one of the bovine-based infant formulas. Intolerance of the first day of bovine-based feedings is common. Yet, the artificial colostrum solution of Table 3 was found to be well tolerated during feedings that were judged by signs of feeding intolerance; emesis, diarrhea, bloating, visible bowel loops, and large pre-feeding gastric residual volumes.

26 NICU patients who had no mother's own colostrum, but who were otherwise ready to begin enteral feedings were tested. The solution of Table 3 was administered in a volume of 2.5 mL/kg every 3 hours for the first eight feedings (24 hrs) for each patient. Demographics of the 26 NICU patients that were fed the solution of Table 3 for their first eight feedings are listed in Table 7.

TABLE 7
NICU patients whose mother's own colostrum was not available, and were fed
the artificial colostrum of Table 3 for the first eight feedings.

| | BW | Gestational | | | Day of life Sylostrum |
|---|---|---|---|---|---|
| N | (grams) | Age (weeks) | Race/Ethnicity | Gender | feedings were begun |
| 26 | 2135 ± 605 | 33.7 ± 3.6 | White 88% | Male 38% | 2.0 ± 0.3 |
| | | | Black 8% | | |
| | | | Hispanic 4% | | |

All 26 patients were fed the artificial colostrum solution of Table 3 as planned, for the first day of feedings. As shown in Table 8, 202 of the 208 feedings that were planned (26 patients X 8 feedings/patient) were given. Six (3%) were not given. One feeding was postponed because of emesis that occurred following endotracheal intubation. One feeding was postponed (a separate neonate) for three hours because of increased abdominal girth. Four feedings were postponed for nonspecified reasons

TABLE 8
Feasibility and tolerance of feedings of artificial
colostrum solution of Table 3.

| | Percent of the planned | Percent of the | Percent of the feedings |
|---|---|---|---|
| | feedings that were | feedings | held because of increased |
| | actually given as | held because | abdominal girth or visible |
| N | planned | of emesis | bowel loops |
| 26 | 97.2 ± 7.3% | 1/208* | 1/208** |
| | (202/208) | | |

*One feeding was postponed because of emesis that occurred following endotracheal intubation (one patient).
**One feeding was postponed on one patient, but was given three hours later when the examination was normal.

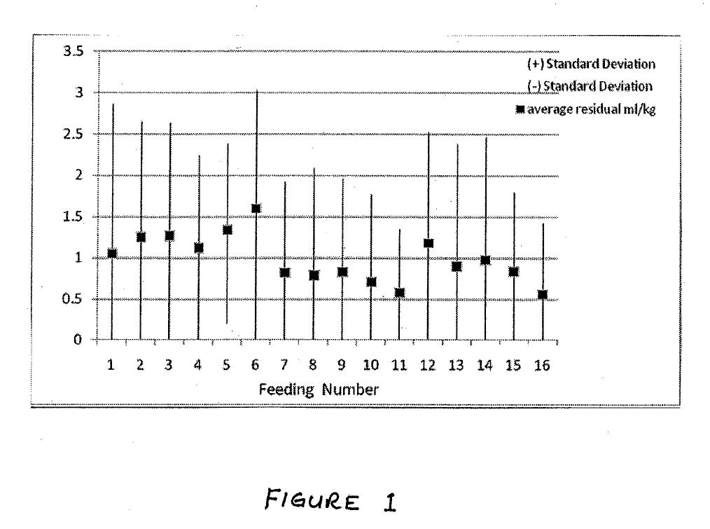

For these NICU patients, FIG. 1 shows the amount of the pre-feeding gastric residual did not increase significantly after any of the eight artificial colostrum feedings or after the eight subsequent milk feedings. Prior to the first feedings, about 1 mL/kg body weight of fluid was detected in the stomach. Accordingly, among this group of 26 NICU patients who had no mother's own colostrum, it was feasible to administer the artificial colostrum solution of Table 3, 2.5 mL/kg every three hours for the first eight feedings. The solution was well tolerated, with fewer than 3% of the planned feedings withheld.

Prefeeding gastric residual volumes measured in NICU patients before their first artificial colostrum of Table 3 feeding was given and before each of their subsequent 16 feedings (two days).

In the foregoing specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented in the claims.

What is claimed is:

1. A synthetic colostrum solution comprising a predetermined quantity of water, carbohydrate, protein, and fat to simulate human colostrum.

2. The solution of claim 1, wherein the carbohydrate comprises lactose at a concentration between 47.7 to 58.3 grams per liter of water.

3. The solution of claim 1, wherein the protein comprises amino acids at a concentration between 20.7 to 25.3 grams per liter of water.

4. The solution of claim 1, wherein the fat comprises cholesterol at a concentration between 270 to 330 milligrams per liter of water, fatty acids at a concentration between 18 to 22 grams per liter of water, or a combination thereof.

5. The solution of claim 1, further comprising predetermined quantities of vitamins, minerals, trace elements, or a combination thereof.

6. The solution of claim 5, wherein the vitamins comprise MVI Ped at a concentration between 27 to 33 millilieters per liter of water, Vitamin E at a concentration between 11520 to 14080 micrograms per liter of water, Vitamin B12 at a concentration between 1800 to 2200 nanograms per liter of water, B Carotene at a concentration between 1008 to 1232 micrograms per liter of water, or a combination thereof; the minerals comprise sodium acetate at a concentration between 432 to 528 milligrams Sodium per liter of water, potassium chloride at a concentration between 666 to 814 milligrams Potassium per liter of water, calcium gluconate at a concentration between 207 to 253 milligrams Calcium per liter of water, magnesium sulfate at a concentration between 31.5 to 38.5 milligrams Magnesium per liter of water, or a combination thereof; and the trace elements comprise zinc at a concentration between 4500 to 5500 micrograms per liter of water, copper at a concentration between 1800 to 2200 micrograms per liter of water, manganese at a concentration between 450 to 550 micrograms per liter of water, iodine at a concentration between 4500 to 5500 micrograms per liter of water, or a combination thereof

7. The solution of claim 1, wherein the energy of the solution is predetermined to be between 453.6 to 554.4 kcal per liter of water.

8. A synthetic colostrum solution comprising a predetermined quantity of water, carbohydrate, fat, and protein that can be mixed with a milk constituent to simulate human colostrum.

9. The solution of claim 8, wherein the milk constituent comprises human milk, lactoferrin, IgA, alpha lactalbumin, human milk fat, or a combination thereof.

10. The solution of claim 8, wherein the carbohydrate comprises lactose at a concentration between 0 to 58.3 grams per liter of water.

11. The solution of claim 8, wherein the protein comprises amino acids at a concentration between 20.7 to 25.3 grams per liter of water.

12. The solution of claim 8, wherein the fat comprises cholesterol at a concentration between 0 to 330 milligrams per liter of water, fatty acids at a concentration between 0 to 22 grams per liter of water, or a combination thereof.

13. The solution of claim 8, further comprising predetermined quantities of vitamins, minerals, trace elements, or a combination thereof

14. The solution of claim 13, wherein the vitamins comprise MVI Ped at a concentration between 27 to 33 millilieters per liter of water, Vitamin E at a concentration between 11520 to 14080 micrograms per liter of water, Vitamin B12 at a concentration between 1800 to 2200 nanograms per liter of water, or a combination thereof the minerals comprise sodium acetate at a concentration between 432 to 528 milligrams Sodium per liter of water, potassium chloride at a concentration between 666 to 814 milligrams Potassium per liter of water, calcium gluconate at a concentration between 207 to 253 milligrams Calcium per liter of water, magnesium sulfate at a concentration between 31.5 to 38.5 milligrams Magnesium per liter of water, or a combination thereof and the trace elements comprise zinc at a concentration between 4500 to 5500 micrograms per liter of water, copper at a concentration between 1800 to 2200 micrograms per liter of water, manganese at a concentration between 450 to 550 micrograms per liter of water, iodine at a concentration between 4500 to 5500 micrograms per liter of water, or a combination thereof.

15. The solution of claim 8, wherein the energy of the solution is predetermined to be between 453.6 to 554.4 kcal per liter of water.

16. A method for making a synthetic colostrum solution comprising adding predetermined quantities of water, carbohydrate, protein, fat, and milk constituents in a mixture that simulates human colostrum.

17. The method of claim 16, further comprising adding predetermined quantities of vitamins, minerals, trace elements, or a combination thereof.

18. The method of claim 16, wherein no carbohydrates are added.

19. The method of claim 16, wherein no milk constituents are added.

20. The method of claim 16, wherein the water comprises sterile water, the carbohydrate comprises lactose, the protein comprises amino acids, the fat comprises cholesterol and fatty acids, and the milk constituents comprise human milk, lactoferrin, IgA, alpha lactalbumin, human milk fat, or a combination thereof.
